(19) United States
(12) Patent Application Publication
(10) Pub. No.: US 2013/0070498 A1
(43) Pub. Date: Mar. 21, 2013

(54) POWER ADJUSTABLE, ISOLATED AND TRANSFORMERLESS AC TO DC POWER CIRCUIT

(71) Applicant: TSUNG-EIN TSAI, TAIPEI CITY (TW)

(72) Inventor: TSUNG-EIN TSAI, TAIPEI CITY (TW)

(73) Assignee: ANN CHENG ENTERPRISE CO., LTD., CHIAYI COUNTY (TW)

(21) Appl. No.: 13/236,899

(22) Filed: Sep. 20, 2011

(51) Int. Cl. H02M 7/06

(52) U.S. Cl. 363/126

(57) ABSTRACT

A power adjustable, isolated and tranformerless AC to DC power circuit is revealed. The AC to DC power circuit includes a first reactance component, a second reactance component, a third reactance component and an AC power connected to form a loop. The third reactance component is connected to an input end of a full bridge rectifier and a filter capacitor is connected across to an output end of the full bridge rectifier for output of a stable low voltage DC. Thereby AC power is isolated to avoid electric conductance or shock. Moreover, the manufacturing cost is dramatically reduced, the power is saved, and no heat is generated. Furthermore, the reactance of the whole circuit is reduced so as to get high power factor. The AC to DC power circuit has no high frequency radiation, no radiation damage and no interference to sensitive electronic equipment.

### BACKGROUND OF THE INVENTION

1. Field of the Invention

The present invention relates to an AC to DC power circuit, especially to a power adjustable, isolated and tranformerless AC to DC power circuit that protects users from getting an electrical shock, saves power and prevents heat generation. Moreover, the manufacturing cost is reduced, the reactance is lowered and the high power factor is achieved. Furthermore, no high frequency radiation is produced; neither is radiation damage and interference to users and sensitive electronic equipment.

2. Description of Related Art

Nowadays portable electronic devices such as mobile phones, notebooks are disposed with a buck power supply circuit respectively. However, most of the electronics devices feature compact and lightweight design. The use of the transformer has negative effect on the compact size of the electronic device. Thus the high frequency switching that converts low frequency power source to high frequency alternating current is used. The high voltage current is reduced by a high frequency transformer with small volume and then is rectified into low voltage direct current. Yet the high-frequency radiation is still generated due to the use of high frequency transformer. The high-frequency radiation has harmful effects on users or causes interference to sensitive electronic equipment nearby.

Some manufacturers produce a novel design of the transformerless AC to DC circuit that provides stable low-voltage DC power without use of transformers. Although such circuit can provide stable low-voltage DC power without transformers, the use of transistors and resistors still has problems such as poor power conversion efficiency and a power factor circuit is required if the power factor of the circuit needs to be improved. Thus there is room for improvement.

### SUMMARY OF THE INVENTION

Therefore it is a primary object of the present invention to provide a power adjustable, isolated and transformerless AC to DC power circuit including an AC to DC power circuit. The AC to DC power circuit consists of a first reactance component, a second reactance component and a third reactance component connected with an AC power [AC/IN] to form a loop. The third reactance component is connected to an input end of a full bridge rectifier so that lower voltage AC at the third reactance component is rectified in a full-wave mode and converted into an unstable low voltage DC. A filter capacitor is connected across to an output end of the full bridge rectifier to filter the unstable low voltage DC and a stable low voltage direct current is output. Thereby the AC is isolated by the first reactance component and the second reactance component so as to avoid electrical conductance or electrical shock. And the AC power is effectively converted into low voltage DC to be outputted without transformers. Thus the cost is reduced. Without passing transformers, the energy is saved and no heat energy is generated. At the same time, the reactance is reduced and high power factor is achieved. The circuit generates no high frequency radiation so that there are no radiation damages to users and no interference to sensitive electronic equipment.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a circuit diagram of an embodiment according to the present invention;

FIG. 2 is a circuit diagram of another embodiment according to the present invention;

FIG. 3 is a circuit diagram of a capacitive reactance component according to the present invention;

FIG. 4 is a circuit diagram of a further embodiment according to the present invention.

### DETAILED DESCRIPTION OF THE PREFERRED EMBODIMENT

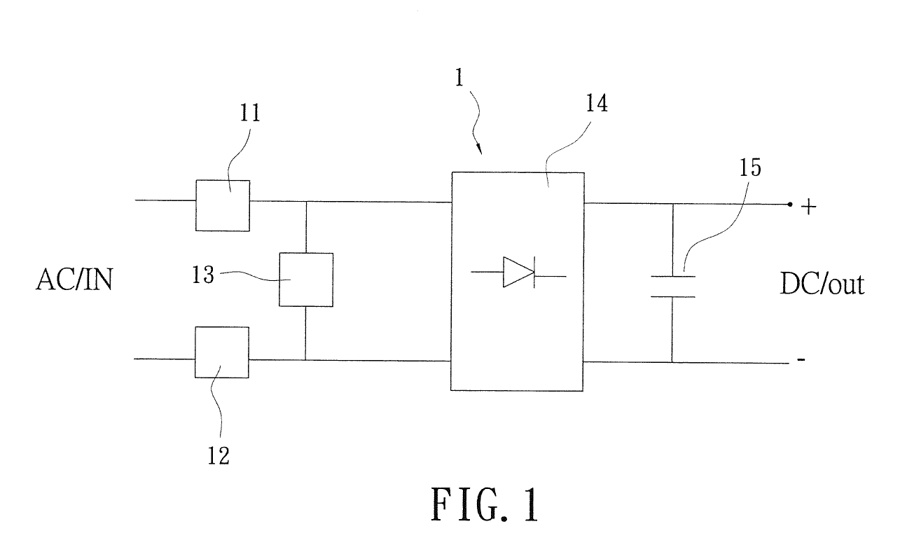

Refer to FIG. 1, an AC to DC power circuit 1 of the present invention includes a first reactance component 11, a second reactance component 12, a third reactance component 13, a full bridge rectifier 14 and a filter capacitor 15 connected with one another.

The first reactance component 11, the second reactance component 12, the third reactance component 13 and an AC power source (AC/IN) form a loop. By the first reactance component 11 and the second reactance component 12, the AC power source is isolated so as to avoid electric conductance and electric shock.

An input end of the full bridge rectifier 14 is connected to the third reactance component 13 and is used for full-wave rectification of lower voltage alternating current from the third reactance component 13, converting the alternating current into unstable low voltage direct current.

The filter capacitor 15 can be an AC capacitor or an electrolytic capacitor, connected across to an output end of the full bridge rectifier 14 so as to filter the unstable low voltage direct current and output a stable low voltage direct current.

In the embodiment of the present invention, the alternating current power source is effectively converted to a low voltage direct current power source by adjustment of an impedance ratio of the first reactance component 11, the second reactance component 12 and the third reactance component 13.

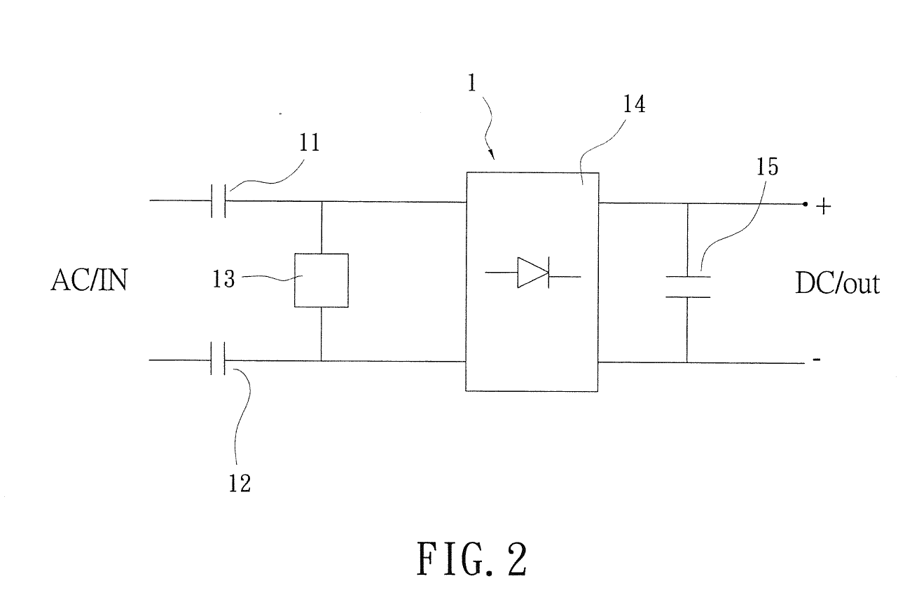

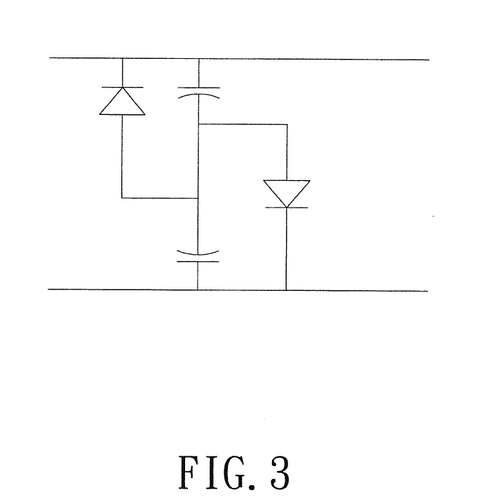

Refer to FIG. 2, a circuit diagram of another embodiment of the present invention is disclosed. Both a first reactance component 11 and a second reactance component 12 are AC capacitors or their effective impedance is capacitive. One end of the first reactance component 11 is connected to an AC power source (AC/IN) and so is the second reactance component while the other end of the first reactance component 11 and the other end of the second reactance component 12 are respectively connected to each of two ends of a third reactance component 13 that is an AC capacitor or whose effective impedance is capacitive. Refer to FIG. 3, a circuit diagram of a capacitive reactance component is revealed. The effective impedance is a capacitive first reactance component 11, a capacitive second reactance component 12 or a capacitive third reactance component 13. All the reactance components 11, 12, 13 are composed of two electrolytic capacitors connected in series by anodes or by cathodes and the anode and the cathode of the each electrolytic capacitor are respectively connected to an anode and a cathode of a diode in parallel. Moreover, the capacitive first reactance component 11, the capacitive second reactance component 12, and the capacitive third reactance component 13 can also respectively be an AC capacitor or having a plurality of AC capacitors connected in series or in parallel.

Thus the AC voltage applied to the third reactance component 13 can be adjusted by impedance ratio of the first reactance component 11, the second reactance component 12 and the third reactance component 13. Take an 110V AC power source as an example. When the first reactance component 11 and the second reactance component 12 are both 22 uF, and the third reactance component 13 whose effective impedance is capacitive includes a 1000 uF electrolytic capacitor, the impedance ratio of the first reactance component 11, the second reactance component 12 and the third reactance component 13 is 45.5:1. The peak alternating current of the third reactance component 13 is +3.4V due to connection of the 110V AC power source. After passing through the full bridge rectifier 14 for rectification and the filter capacitor 15, the output voltage is about 6.8V (3.4V+3.4V=6.8V). This is consistent with the value of the detected direct current voltage 7.0V. Thus the present invention can convert the AC power to low voltage direct current power.

If the above first reactance component 11/the second reactance component 12 is an AC capacitor, they can be connected to a discharge resistor in parallel. When the AC power is off, voltage in the first reactance component 11 or the second reactance component 12 is discharged quickly by the discharge resistor so as to avoid electric shock.

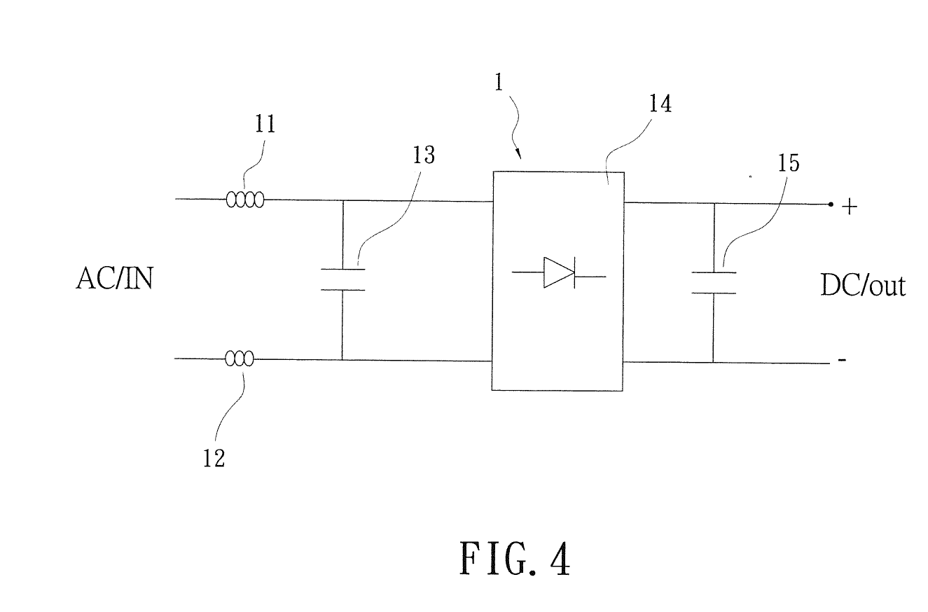

Refer to FIG. 4, a further embodiment of the present invention is revealed. The effective impedance of the first reactance component 11, the effective impedance of the second reactance component 12 and the effective impedance of the third reactance component 13 can be inductive or capacitive. If the effective impedance is inductive, the first reactance component 11, the second reactance component 12 and the third reactance component 13 can be an AC inductor, a plurality of AC inductors connected in series or a plurality of AC inductors connected in parallel. The impedance of the inductor and the impedance of the capacitor cancel each other out. Thus reactance of the whole circuit, together with load, is reduced to the minimum value so as to get the maximum power factor. For example, take the AC to DC power circuit applied to a 220V AC power for driving LED lights as an example. When the first reactance component 11 is 1.3 mH, the second reactance component 12 is 1.3 mH, and the third reactance component 13 is 0.22 nF, while the filter capacitor 15 is 0.068 uF, 90 one-third Watt LED lights connected in series are activated, the output DC voltage is 243V and the output DC is 0.1 A. Although 30 W, 220V AC is required, only 0.16 A is used and the power factor is over 0.9. Thus the present invention not only converts AC power to DC power but also satisfies the requirement of high power factor.

Furthermore, the effective impedance of the first reactance component 11, the second reactance component 12 and the third reactance component 13 can also be resistance type. The first reactance component 11, the second reactance component 12, or the third reactance component 13 whose effective impedance is resistance type can be a single resistance, a plurality of resistance elements connected in series, or a plurality of resistance elements connected in parallel. The design can also convert AC power to DC power and meets the requirement of high power factor.

In summary, compared with the structure available now, the present invention includes the first reactance component and the second reactance component so as to isolate the AC power. While the AC to DC power circuit being applied with current, the AC power and users are isolated by the first and the second reactance components to avoid electric conductance or electric shock. While not in use for power conversion, the static electricity is isolated by the first and the second reactance components to avoid the conductive. Moreover, the cost is reduced without transformers. Without passing transformers, the energy is also saved and no heat energy is generated. Furthermore, the reactance is reduced and high power factor is achieved. In addition, no high frequency radiation is generated so that the circuit has no radiation damages to users and no interference to sensitive electronic equipment.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A power adjustable, isolated and transformerless AC(alternating current) to DC(direct current) power circuit comprising an AC to DC power circuit having a first reactance component, a second reactance component, a third reactance component, a full bridge rectifier and a filter capacitor connected one another; wherein
the first reactance component, the second reactance component, the third reactance component, and an AC power (AC/IN) form a loop; the AC power is isolated by the first reactance component and the second reactance component to avoid electric conductance or electric shock;
the full bridge rectifier whose input end thereof is connected to the third reactance component is for full-wave rectification of lower voltage alternating current from the third reactance component, converting the lower voltage alternating current into unstable low voltage direct current;
the filter capacitor is connected across to an output end of the full bridge rectifier so as to filter the unstable low voltage direct current and output stable low voltage direct current.

2. The device as claimed in claim 1, wherein the filter capacitor is an AC capacitor or an electrolytic capacitor.

3. The device as claimed in claim 1, wherein effective impedance of the first reactance component is capacitive, inductive, or resistance.

4. The device as claimed in claim 1, wherein effective impedance of the second reactance component is capacitive, inductive, or resistance.

5. The device as claimed in claim 1, wherein effective impedance of the third reactance component is capacitive, inductive, or resistance.

6. The device as claimed in claim 3, wherein the first reactance component whose effective impedance is capacitive is a single AC capacitor, a plurality of AC capacitors connected in series, a plurality of AC capacitors connected in parallel, two electrolytic capacitors connected in series by anodes thereof while an anode and a cathode of each electrolytic capacitor are respectively connected to an anode and a cathode of a diode in parallel, or two electrolytic capacitors connected in series by cathodes thereof while an anode and a cathode of each electrolytic capacitor are respectively connected to an anode and a cathode of a diode in parallel.

7. The device as claimed in claim 3, wherein the first reactance component whose effective impedance is inductive is a single AC inductor, a plurality of AC inductors connected in series or a plurality of AC inductors connected in parallel.

8. The device as claimed in claim 3, wherein the first reactance component whose effective impedance is resistance is a single resistor, a plurality of resistors connected in series, or a plurality of resistors connected in parallel.

9. The device as claimed in claim 4, wherein the second reactance component whose effective impedance is capacitive is a single AC capacitor, a plurality of AC capacitors connected in series, a plurality of AC capacitors connected in parallel, two electrolytic capacitors connected in series by anodes thereof while an anode and a cathode of each electrolytic capacitor are respectively connected to an anode and a cathode of a diode in parallel, or two electrolytic capacitors connected in series by cathodes thereof while an anode and a cathode of each electrolytic capacitor are respectively connected to an anode and a cathode of a diode in parallel.

10. The device as claimed in claim 4, wherein the second reactance component whose effective impedance is inductive is a single AC inductor, a plurality of AC inductors connected in series or a plurality of AC inductors connected in parallel.

11. The device as claimed in claim 4, wherein the second reactance component whose effective impedance is resistance is a single resistor, a plurality of resistors connected in series, or a plurality of resistors connected in parallel.

12. The device as claimed in claim 5, wherein the third reactance component whose effective impedance is capacitive is a single AC capacitor, a plurality of AC capacitors connected in series, a plurality of AC capacitors connected in parallel, two electrolytic capacitors connected in series by anodes thereof while an anode and a cathode of each electrolytic capacitor are respectively connected to an anode and a cathode of a diode in parallel, or two electrolytic capacitors connected in series by cathodes thereof while an anode and a cathode of each electrolytic capacitor are respectively connected to an anode and a cathode of a diode in parallel.

13. The device as claimed in claim 5, wherein the third reactance component whose effective impedance is inductive is a single AC inductor, a plurality of AC inductors connected in series or a plurality of AC inductors connected in parallel.

14. The device as claimed in claim 5, wherein the third reactance component whose effective impedance is resistance is a single resistor, a plurality of resistors connected in series, or a plurality of resistors connected in parallel.

15. The device as claimed in claim 1, wherein the first reactance component and the second reactance component are connected to a discharge resistor in parallel.
